(19) United States
(12) Patent Application Publication
(10) Pub. No.: US 2026/0157410 A1
(43) Pub. Date: Jun. 11, 2026

(54) METHOD OF PRODUCING A FOOD PRODUCT, FOOD PRODUCT AND APPARATUS

(71) Applicant: NE INNOVATIONS OY, Helsinki (FI)

(72) Inventor: Santtu VEKKELI, Helsinki (FI)

(21) Appl. No.: 19/129,225

(22) PCT Filed: Nov. 10, 2023
(86) PCT No.: PCT/FI2023/050628

§ 371 Date: May 12, 2025

(30) Foreign Application Priority Data
Nov. 11, 2022 (FI) 20226014
Jan. 11, 2023 (FI) 20235032

(51) Int. Cl. A23L 17/00; A23L 17/10; A23P 30/20

(52) U.S. Cl. CPC A23L 17/70; A23L 17/10; A23P 30/20

(57) ABSTRACT

It is disclosed a method of producing a food product for human consumption from undervalued parts of a fish material by using extrusion. The method comprises: providing a fish material containing hard tissues; optionally providing a stabilizing material; optional grinding the fish material with a grinder having a hole size of at most 2 mm to provide a fish mass; subjecting the fish material to a first colloid milling to provide a colloid milled fish mass; subjecting the colloid milled fish mass to an extrusion to provide an extruded fish mass; subjecting the extruded mass to a second colloid milling to provide a colloid milled extruded fish mass as a food product.

### FIELD OF THE INVENTION

The present invention relates to a method of producing a food product. More particularly, the invention relates to a method of producing a food product by extrusion from a fish material including undervalued parts of fish. The invention also relates to a food product produced by the method of the invention.

### BACKGROUND OF THE INVENTION

Extrusion is widely used in the manufacture of various food products. Broadly, extrusion is a continuous process which uses an extruder having one or two screws. The extruder provides transport, compression, mixing, cooking, shearing, heating, cooling and shaping of raw material to final products.

Anni Nisov et al., Comparison of Whole and Gutted Baltic Herring as a Raw Material for Restructured Fish Product Produced by High-Moisture Extrusion Cooking, Foods 2020, 9 1541, pages 1-12, discloses the microbiological safety, sensory properties and structure properties of whole ungutted fish and gutted fish in high-moisture extrusion cooking with incorporation of plant protein.

### BRIEF DESCRIPTION OF THE INVENTION

It has now been found that a food product for human consumption with satisfactory organoleptic properties, such as appealing taste and good mouthfeel, may be produced from undervalued parts of a fish material by extrusion without a stabilizing material. The fish material be whole fish or gutted fish, or only hard tissues of a fish material. The invention thus provides a method of producing a valuable food product with consumer acceptable organoleptic properties from un undervalued fish material.

In the context of the invention, the term “stabilizing material-free” means that the food product does not contain a plant protein material, an animal protein material, egg protein, a plant carbohydrate material, plant fiber material or any mixture of said materials.

The invention provides a sustainable method in which whole or gutted fish is effectively used in the production of a ready-to-consume food product for human consumption providing environmental benefits.

The invention also provides a method in which undervalued parts of a fish material or of low hygienic quality may be used providing economic benefits in that the product can be offered at a lower cost.

The invention further provides a method of producing a food product with an increased nutritional value.

Further, the invention provides a method of producing a food product which enables reduction of global meat production providing environmental benefits.

The invention also provides a method of producing a food product with high microbiological quality and substantially eliminated Salmonella bacteria.

The food product can be used as an ingredient or an extender and combined with other food materials to produce a wide variety of food compositions.

The food product produced by the method of the invention is also suitable as an animal feed.

In an aspect, the present invention provides a method for producing a food product from a fish material without a stabilizing material including undervalued parts of fish.

In an aspect, the invention provide a food product obtainable by the method of the invention.

In an aspect, the invention provides a food product comprising a fish material comprising fish bones, wherein the calcium content of the food product is in the range of about 0.2 wt-% to about 4.0 wt-%.

In a further aspect, the invention provides a food composition comprising a food product produced by the method of the invention or a food product of the invention.

In an aspect, the invention provides use of a food product of the invention or a food product produced by the method of the invention in the food compositions.

In further aspect, the invention provides an apparatus comprising means for implementing the method of the invention.

### BRIEF DESCRIPTION OF THE DRAWINGS

FIG. 1 generally illustrates a process flow diagram of an embodiment of the method of the invention.

FIG. 2 generally illustrates a process flow diagram of another embodiment of the method of the invention.

FIG. 3 illustrates an embodiment of an apparatus of the invention.

FIG. 4 illustrates another embodiment of an apparatus of the invention.

### DETAILED DESCRIPTION OF THE INVENTION

In an aspect, the present invention provides a method of producing a food product, comprising
providing a fish material containing hard tissues,
optionally providing a stabilizing material,
optional grinding the fish material with a grinder having a hole size of at most 2 mm to provide a fish mass,
subjecting the fish material to a first colloid milling to provide a colloid milled fish mass,
subjecting the colloid milled fish mass to an extrusion to provide an extruded fish mass,
subjecting the extruded fish mass to a second colloid milling to provide a colloid milled extruded fish mass as a food product.

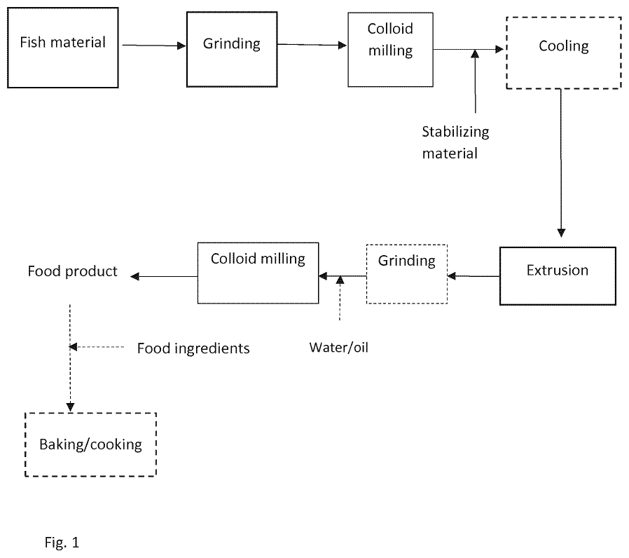

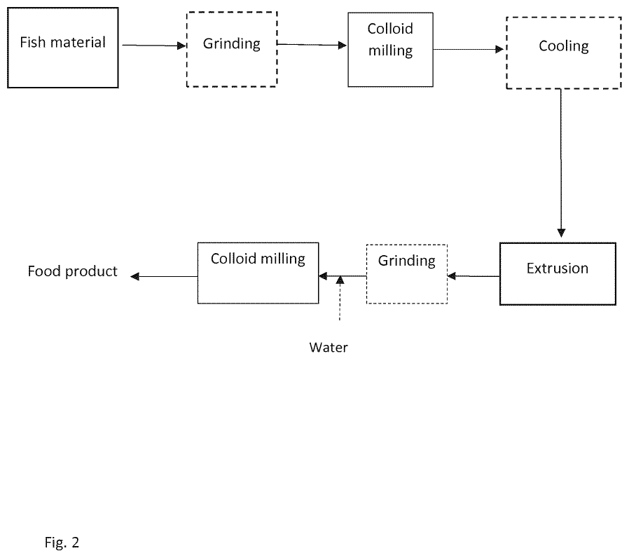

FIG. 1 illustrates an embodiment of the method of the invention. FIG. 2 illustrates another embodiment of the method of the invention. The dotted line in FIGS. 1 and 2 illustrate optional method steps. The methods may include further optional method steps not shown in the figures.

The fish material suitable for use in the method of the invention includes any fish species suitable for human consumption, for example salmon or Baltic herring. In an embodiment, the fish material is whole fish or gutted fish. In an embodiment, the fish material comprises hard tissues of fish, i.e., fish bones, scales, head or fins. In an embodiment, the fish material consists of hard tissues selected from fish bones, scales, head, fins and any mixture thereof. In an embodiment, the fish material comprises at least bones. The fish material can also comprise or consists of skin. In an embodiment, the fish material contains up to about 90 wt-% of hard tissues selected from fish bones, scales, head and fins. In an embodiment, the fish material contains about 30 wt-% to about 90 wt-% of hard tissues.

In the method, the fish material comprising hard tissues is optionally ground with a grinder having a hole size of at most 2 mm to provide a fish mass.

In an embodiment, the method of the invention comprises a pH adjustment step. In an embodiment, the pH of the fish material is adjusted to about 2 to about 6 with a food grade acid. The food grade acid can be citric acid. In an embodiment, the pH adjustment step is performed before extrusion.

The fish material is subjected to a first colloid milling step to mince the particles included in fish material to smaller pieces. Generally, “colloid mill” is a machine which has a high-speed rotor and a stator providing superfine grinding results along with simultaneous emulsifying, homogenizing, and dispersing. The rotor pushes the material into small gaps between the rotor and stator causing in-tense mechanical shear. In the present invention, colloid milling provides a homogenous, ultra-fine bone particles of bone-containing fish mass and beneficially enhances softening of bone particles in the subsequent wet extrusion. In an embodiment, colloid milling of the fish mass provides bone particles having an average particle size above 50 μm up to about 200 μm. However, there can be some individual particles present having a bigger particle size.

In an embodiment of the method of the invention, a stabilizing material-free food product is product. In another embodiment, the method of the invention comprises a step of including a stabilizing material into the food product. The stabilizing material is employed to stabilize extrusion process so that no substantial separation of water, oil and a solid material in the mixture of the colloid milled fish mass and the stabilizing material during the extrusion is observed. In an embodiment, the stabilizing material comprises a plant protein material, an animal protein material, egg protein, a plant carbohydrate material, plant fiber material or any mixture of said materials. In an embodiment, the stabilizing material is in powdered form. In an embodiment, the stabilizing material is fish meal powder. In another embodiment, the stabilizing material is a soy protein concentrate.

The stabilizing material used in the method of the invention exhibits a water holding capacity (WHC) of about 0.5 g/g dry stabilizing material to about 13 g/g dry stabilizing material.

The water holding capacity was determined as follows: Centrifuge bottle is weighed. 15 g of a dried stabilizing material and 60 g of distilled water are put into a centrifuge bottle. The bottle is placed to a shaker and shaken for 5 minutes at 300 rpm and then centrifuged at a centrifugal force at 2800 rpm for 20 minutes. The supernatant is decanted and the bottle weighed. Water holding capacity is the stabilizing material is calculated as percentage based on dry weight of the stabilizing agent.

In the embodiment where the stabilizing material is not employed in the method, the colloid milled fish mass is subjected to an extrusion to provide a solid extruded fish mass.

In the embodiment where the stabilizing material is employed in the method, the stabilizing material is added to the colloid milled fish mass. The colloid milled fish mass containing the stabilizing material is then subjected to the extrusion to provide an extruded fish mass.

The colloid milled fish mass contains about 1 wt-% to about 50 wt-% of the stabilizing material based on weight of the colloid milled fish mass. In another embodiment, the colloid milled fish mass contains about 1 wt-% to about 15 wt-% of the stabilizing material.

In an embodiment, the extrusion is performed at a moisture of at least 20%. In an embodiment, the extrusion is a wet extrusion to provide an extruded mass. In context of the present invention, the term “wet extrusion” means that the colloid milled fish mass, optionally containing the stabilizing material, to be extruded has a moisture content of at least 30%. In an embodiment, the moisture content is in the range of 30% to about 70%. If the moisture content is lower than 30%, it may be difficult to carry out the extrusion process, since the colloid milled fish mass in the extruder is dry. On the other hand, if the moisture content is higher than 70%, liquid may undesirably separate from the dry matter of the colloid milled fish mass.

The extrusion may be carried out with a single-screw or twin-screw extruder. Shearing and tearing combined with moisture in the extrusion step causes softening of the hard tissues of fish and provides a unique structure to the final food product.

In an embodiment, the extrusion is performed at a temperature of about 100° C. to about 400° C. Depending on the extruder used in the method, the extruder has to contain at least one heating segment where the temperature is at least 100° C. In addition, there may be further heating segments where the extrusion may be performed below 100° C., e.g., at 70° C. In an embodiment of the invention, an extruder is used which contains several heating segments each operated at a different temperature. In an embodiment, the temperature of the heating segments increases when the mass moves forward in the extruder.

The duration of the extrusion step is dependent on the apparatus construction and settings.

In an embodiment, the extrusion in the method is performed using about 100 rpm to about 1000 rpm speed. In another embodiment, the extrusion is performed using about 200 rpm to about 600 rpm speed. In an embodiment, about 500 rpm is employed in the extrusion.

In an embodiment, the extrusion provides an extruded mass having a temperature of at least 100° C.

In an embodiment, the extruded mass is cooled to a temperature of about +60° C. to about −30° C. In an embodiment, cooling of the extruded mass is performed in an extruder before the extruded mass is discharged from the extruder. Cooling in the extruder is conveniently carried out in the cooling die. When the extruded mass is cooled in the extruder, the temperature of the mass discharged from the extruder may range from about 1° C. to about 80° C., or from about 1° C. to about 60° C. In an embodiment, the temperature of the extruded mass is in the range from about 30° C. to about 60° C.

In another embodiment of the invention, the colloid milled fish mass, optionally containing the stabilizing material, in the extruder is pressed thorough a hole, which may be smaller than or equal to the cylinder area in the end of the extrusion cylinder. Extruded mass loses a portion of water steam when it exits the process, if the temperature is more than 100° C. The mass has a different taste, smell, structure (viscosity, cutting properties etc.), and it reacts differently in post-processing compared with a process involving a cooling die step.

The extrusion of the colloid milled fish mass, optionally containing the stabilizing material, provides a solid extruded fish mass which is further subjected to a second colloid milling to further mince the particles in the extruded mass and to improve the sensory properties of the obtained food product. The second colloid milling may be the same as or different from the first colloid milling. In an embodiment, water and/or oil is added to the extruded mass before colloid milling to enhance the mincing effect of colloid milling.

The second colloid milling of the solid extruded fish mass provides a food-grade product with appealing sensory properties which is ready to be consumed as such. Two times colloid milled food product exhibits a smooth mouth feel without observable bone particles present. The food product shows an average particle size of at most 50 μm. In an embodiment, the average particle size is in the range of about 25 μm to about 50 μm. In another embodiment, the average particle size is in the range of about 1 μm to about 15 μm.

Extrusion process decreases microbial load a fish material enabling use of fish of low hygienic quality. Microbial load is reduced by approximately 1000-10¹² fold during the process.

The extruded food product produced by the method of the invention may imitate the texture, flavour, and mouthfeel of meat.

The method of the invention provides a food product which exhibits an increased nutritional value. By using calcium-containing parts of a fish material, i.e., bones, the calcium content of the food product produced by the method is increased. In an embodiment, the food product has a calcium content of about 0.2 wt-% to about 4.0 wt-%. In another embodiment, the calcium content of the food product is about 0.3 wt-% to about 2.0 wt-%. In a further embodiment, the calcium content of the food product is about 1.2 wt-% to about 1.5 wt-%.

The method of the invention provides a food product which has a protein content from about 5 wt-% to about 30 wt-%, a fat content from about 2 wt-% to about 30 wt-%, dry matter of about 30 wt-% to about 70 wt-%, and a pH from about 3 to about 7.5.

In an embodiment, the food product is heat-treated at a temperature ranging from about 110° C. to about 400° C. to further improve sensory properties and mouthfeel of the product. The heat treatment may be carried out, e.g., by cooking in oil, e.g., at 150-300° C., grilling, pan frying, drying by heat, e.g., at 200-400° C., freeze drying below −70° C., microwaving or infrared radiating.

Extrusion of a fish material, such as whole fish including undervalued parts, such as fish bones and other hard tissues, together with heat treatment provides a ready-to-eat food product for human consumption which shows unique, appealing taste and structure, and mouthfeel.

The sensory properties of the food product may be further improved by adding ingredients typically used in food manufacture to the food product produced by the method of the invention, e.g., flavouring agents, aromas, salt, emulsifiers, carbohydrates, fibres, oils and fats, etc.

The extruded food product produced by the method of the invention may be combined with other food materials to provide a wide variety of food compositions having different appearance, taste and structure. Thus, in an aspect, the invention provides use of a food product produced by the method of the invention as an ingredient or extender in the production of food compositions. The food product produced by the method of the invention may be included in the foodstuff in an amount up to about 50 wt-% without imparting any negative effect on the sensory properties of the food composition.

In an embodiment, the food product is mixed with water in a ratio of 3:1 (w/w) to provide an aqueous fish mass. Salt may be added to an aqueous fish mass, e.g., to provide a salt content of about 2 wt-% to the mass. The aqueous fish mass may then be added to a fish fillet by needling it inside the fish fillet, e.g., in a ratio of 1:10 (w/w). Needling is appropriately performed in several injection steps.

In another aspect, the invention provides a food product comprising a fish material comprising fish bones, wherein the calcium content of the food product is in the range of about 0.2 wt-% to about 4.0 wt-%. In another embodiment, the calcium content of the food product is about 0.3 wt-% to about 2.0 wt-%. In a further embodiment, the calcium content of the food product is about 1.2 wt-% to about 1.5 wt-%.

The food product of the invention has a protein content from about 5 wt-% to about 30 wt-%. The fat content of the food product is from about 2 wt-% to about 30 wt-%. The dry matter of the food product is from of about 30 wt-% to about 70 wt-%. The pH of the food product is from about 3 to about 7.5.

In another aspect, the invention provides a food composition comprising a food product produced by the method of the invention or a food product of the invention.

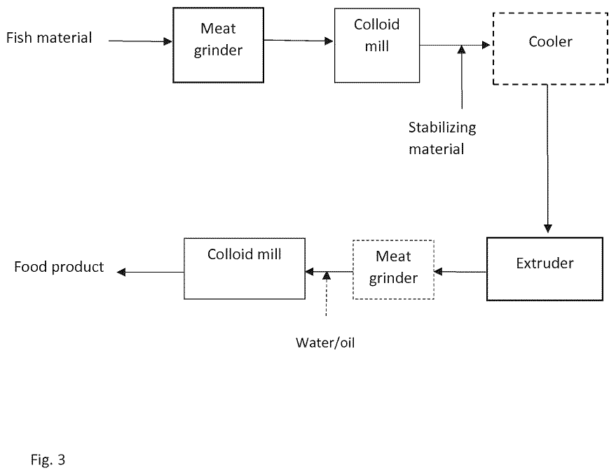

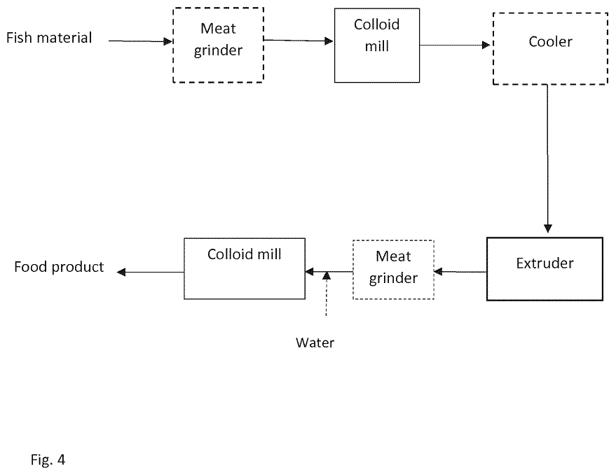

In a further aspect, the invention provides an apparatus for implementing the method of the invention, comprising means for implementing the method of the invention. An embodiment of the apparatus of the invention is illustrated in FIG. 3. Another embodiment of the apparatus of the invention is illustrated in FIG. 4. The dotted line illustrates optional units. The apparatuses may include further optional units not shown in the figures.

In an embodiment, the means comprises
an optional meat grinder for grinding a fish material to provide a fish mass,
a first colloid mill optionally connected with the meat grinder and configured to receive the fish mass,
an extruder connected with the first colloid mill and configured to receive the colloid milled fish mass to provide an extruded mass,
a second colloid mill connected with the extruder and configured to receive the extruded mass to provide a food product.

The following examples are presented for further illustration of the invention without limiting the invention thereto.

The calcium content of the food product was measured according to standard SFS-EN ISO 11885, 2009.

The level of aerobic microorganisms was measured according to standard NMKL 86: 2013.

The amount of Salmonella was measured according to ISO/DIS 20976-2.

### EXAMPLE 1

100 kg of fish (gutted Salmon) containing about 90% in total of head, scales and fins, and 10% of muscle mass was colloid milled to a fine fish mass having a diameter of hard tissue particles of about 100 μm.

The fine fish mass was kept at approximately 4° C. The mass was then loaded to a silo connected to a conveyor screw that was connected to a hopper with approximately 30 liters of volume. The mass was led from the hopper with an auger and a screw to an extruder in a controlled manner at about 55 kg/h. The moisture content of the mass was about 65 wt-%. The mass was extruded at 170 rpm. Heating zones of the extruder were adjusted to a temperature of 60° C., 70° C., 80° C., 100° C., 120° C., 150° C. and 170° C.

The extruder was provided with a cooling die. The first zone of the cooling die was set to 35° C. and the last zone to 35° C. The extrusion process took about one minute.

Extruded, solid fish mass exited the cooling die at a temperature of less than 100° C. Only a small amount of steam was released in the process. Solid fish mass and some amounts of separated oil exited the end of the cooling die.

The level of aerobic microorganisms of the solid fish mass obtained from the extrusion was measured at 30° C./72 h. The solid fish mass showed <100 pmy/g, while the fine fish mass subjected to extrusion showed more than 1 000 000 pmy/g. The measured level of aerobic microorganisms indicates that a food grade product for human consumption was obtained.

Water was added to the solid fish mass each in a ratio of 1:10 (w/w) and was left to be absorbed by the mass at 30° C. for 20 minutes and mixed. Batches of the mass were then milled with a colloid mill. The colloid milling provided a milled fish mass which is a ready-to-consume food product with appealing sensory properties.

The food product had a calcium content of 2 wt-%.

The food product exhibited 7-log reduction of Salmonella bacteria indicating that Salmonella was completely eliminated.

The colloid milled fish mass was mixed with water in a ratio of 3:1 (w/w) to provide an aqueous fish mass. Salt was added so as to provide an aqueous fish mass having 2 wt-% of salt. The aqueous fish mass was added to Salmon fillet at 2° C. by needling it inside the Salmon fillet in a ratio of 1:10 (w/w) in total 50 separate injection steps.

### EXAMPLE 2

80 kg of fish (gutted Salmon) containing about 70% in total of bones, head, scales and fins, and 10% of skin was minced with a meat grinder with a hole size of 2 mm. The ground mass was then colloid milled to a fine fish mass having a diameter of hard tissue particles of about 100 μm.

The milled fish mass was properly mixed with 20 kg of fish meal powder (Baltic herring having a protein content of 66 wt-%). The WHC of the fish meal powder was 2.2 g/g dry stabilizing material. The resultant mixture was kept at approximately 4° C. The mixture was then loaded to a silo connected to a conveyor screw that was connected to a hopper with approximately 30 liters of volume. The mixture was led from the hopper with an auger and a screw to an extruder in a controlled manner at about 55 kg/h.

The mixture of the milled fish mass and the fish meal powder was led to an extruder which had a cooling die integrated therewith. The moisture content of the mixture was about 55 wt-%. The mixture was extruded at 170 rpm. Heating zones of the extruder were adjusted to a temperature of 60° C., 70° C., 80° C., 100° C., 120° C., 150° C. and 170° C. The first zone of the cooling die was set to 35° C. and the last zone to 35° C. The extrusion process took about one minute.

Extruded, solid mass exited the cooling die at a temperature of less than 100° C. Only a small amount of steam was released in the process. Solid mass and some amounts of separated oil exited the end of the cooling die.

The level of aerobic microorganisms of the solid mass obtained from the extrusion was measured at 30° C./72 h. The solid mass showed <100 pmy/g, while the mixture subjected to extrusion showed more than 1 000 000 pmy/g. The measured level of aerobic microorganisms indicates that a food grade product for human consumption was obtained.

The food product, i.e., solid extruded mass, had a calcium content of 1.2 wt-%.

The solid mass exhibited 7-log reduction of Salmonella bacteria indicating that Salmonella was completely eliminated.

The solid mass was ground with a meat grinder having a hole size of 2 mm. Sunflower oil and water were both added to the ground mass each in a ratio of 2:10 (w/w) and were left to be absorbed by the mass at 4° C. for 60 minutes. Batches of the mass were then milled with a colloid mill. The colloid milling provided a milled mass which is a ready-to-consume food product with appealing sensory properties.

The milled mass may also be used as an ingredient of a food composition in an amount up to 50 wt-% of the total weight of the food composition.

### EXAMPLE 3

Extruded mass was produced in a similar manner as in Example 2 except that 80 kg of gutted Salmon's head and fish bones with some muscle mass was used. Instead of fish meal powder, a soy protein concentrate having a protein content of 66 wt-% and a WHC of 4.5 g/g dry stabilizing material was used as a raw material.

The pH of the fish mass was adjusted to 5 by adding an aqueous 10% citric acid to the mass.

The colloid milled extruded mass was torn to particles having a particle size of about 1-5 mm. Fresh Salmon fillet meat was added to the particles in a ratio of 85:15 (w/w) followed by adding 10% boiled potato mass. The resultant mixture was ground by a meat grinder with a 5 mm sieve to provide a dough.

2.0 wt-% of salt and spices including black pepper powder, hot pepper powder, cumin powder, garlic powder, onion powder and dill were added to the dough. The dough was kneaded for about 20 minutes until a smooth mass was obtained. The mass was formed to 5 cm balls and put to the top of oil-coated aluminum foil, baked in an oven at 200° C. for about 15 minutes until the internal temperature of 80° C. of the kebab-like mass was reached.

The product was cooled to +4° C. and vacuum packaged.

The resultant fishball-like food product exhibited an appealing taste and mouthfeel.

### EXAMPLE 4

100 kg of fresh rainbow trout (Oncorhynchus mykiss) including heads and spines in total of about 70% of hard tissues was minced with a meat grinder with a hole size of 2 mm. The ground mass was then colloid milled to a fine fish mass.

The colloid milled mixture was kept at approximately 4° C. The mixture was then loaded to a silo connected to a conveyor screw that was connected to a hopper with approximately 30 liters of volume. The mixture was led from the hopper with an auger and a screw to an extruder in a controlled manner at about 30 kg/h.

The mixture was led to an extruder which had a cooling die integrated therewith. The moisture content of the mixture was about 50 wt-%. The mixture was extruded at 130 rpm. Heating zones of the extruder were adjusted to a temperature of 60° C., 70° C., 80° C., 120° C., 150° C., 160° C. and 180° C. The first zone of the cooling die was set to 30° C. and the last zone to 30° C. The extrusion process took about one minute.

Extruded, solid mass exited the cooling die at a temperature of less than 100° C. Only a small amount of steam was released in the process. Solid mass and some amounts of separated oil exited the end of the cooling die.

The level of aerobic microorganisms of the solid mass obtained from the extrusion was measured at 30° C./72 h. The solid mass showed <100 pmy/g, while the mixture subjected to extrusion showed more than 1 000 000 pmy/g. The measured level of aerobic microorganisms indicates that a food grade product for human consumption was obtained.

The solid mass exhibited 7-log reduction of Salmonella bacteria indicating that Salmonella was completely eliminated.

Rapeseed oil and water were both added to the ground mass each in a ratio of 1:15 (w/w) and was mixed mechanically. Batches of the mass were then milled with a colloid mill. The colloid milling provided a milled mass which is a ready-to-consume food product.

The ready-to-consume food product had a following composition: calcium 1.3 wt-% (CP-MS: SFS-EN ISO 11885, 2009; NMKL 1616, 1998), fat 24 wt-% (AOAC n:o 922.06 (LA1004P) (TL95)), carbohydrates 0%, protein 14 wt-% (SFS-EN ISO 14891: 2002; SFS-EN ISO 16634-1: 2009; SFS-EN), sodium 0.1 wt-% (SFS-EN ISO 11885, 2009; NMKL 161, 1998 (TL 25), ash 3 wt-% (NMKL 173/2005 (LA1007P) (TL95)), moisture 55 wt-% (NMKL 169: 2002 (LA1005P) (TL95)), energy content 1200 kJ/100g.

The food product may also be used as an ingredient of a food composition in an amount up to 70 wt-% of the total weight of the food composition.

It will be obvious to a person skilled in the art that, as the technology advances, the inventive concept can be implemented in various ways. The invention and its embodiments are not limited to the examples described above but may vary within the scope of the claims.

1. A method of producing a food product, comprising
providing a fish material containing hard tissues,
optionally providing a stabilizing material,
optional grinding the fish material with a grinder having a hole size of at most 2 mm to provide a fish mass,
subjecting the fish material to a first colloid milling to provide a col-loid milled fish mass,
subjecting the colloid milled fish mass to an extrusion to provide an extruded fish mass,
subjecting the extruded fish mass to a second colloid milling to pro-vide a colloid milled extruded fish mass as a food product.

2. The method of claim 1, wherein the fish material containing hard tissues is whole ungutted fish or gutted fish containing at least one of fish bones, scales, head and fins.

3. The method of claim 1, wherein the fish material contains up to 90 wt-%, specifically about 30 wt-% to about 90 wt-%, of hard tissues selected from fish bones, scales, head and fins.

4. The method of claim 1, wherein the fish material contains fish bones.

5. The method of claim 1, wherein the stabilizing material is selected from a plant protein material, an animal protein mate-rial, egg protein, a plant carbohydrate material, plant fiber material and any mixture of said materials.

6. The method of claim 1, wherein the stabilizing material is powder.

7. The method of claim 1, wherein the stabilizing material is fish meal powder or a soy protein concentrate.

8. The method of claim 1, wherein the first colloid milling provides a colloid milled fish mass including particles of a particle size above 50 μm up to about 200 μm.

9. The method of claim 1, wherein a stabilizing material-free food product is produced.

10. The method of claim 1, wherein the stabilizing material is provided and added to the colloid milled fish mass before the colloid milled fish mass is subjected to the extrusion.

11. The method of claim 10, wherein the stabilizing material is added in the amount of about 1 wt-% to about 50 wt-%, specifically about 1 wt-% to about 15 wt-%, based on the weight of the colloid milled fish mass.

12. The method of claim 1, wherein the extrusion of the colloid milled fish mass is performed at a moisture content of at least 20%, specifically in the range of about 30% to about 70%.

13. The method of claim 1, wherein the pH is adjusted to about 2 to about 6 with a food grade acid before extrusion.

14. The method of claim 1, wherein the extrusion is performed at a temperature of 100° C. to about 400° C.

15. The method of claim 1, wherein the temperature of the extruded mass is at least 100° C.

16. The method of claim 1, wherein the extrusion is performed using about 100 rpm to about 1000 rpm speed, specifically about 200 rpm to about 600 rpm speed, more specifically about 500 rpm.

17. The method of claim 1, wherein the food product has an average particle size of at most 50 μm, specifically about 25 μm to 50 μm, more specifically about 1 μm to about 15 μm.

18. The method of claim 1, wherein the food product has a calcium content of about 0.2 wt-% to about 4.0 wt-%, specifically about 0.3 wt-% to about 1.5 wt-%, more specifically about 1.2 wt-% to about 1.5 wt-%.

19. The method of claim 1, wherein the food product has a water holding capacity (WHC) of about 0.5 g/g dry stabilizing material to about 13 g/g dry stabilizing material.

20. The method of claim 1, wherein the food product has at least one of the following characteristics:
a protein content from about 5 wt-% to about 30 wt-%,
a fat content from about 2 wt-% to about 30 wt-%,
dry matter of about 30 wt-% to about 70 wt-%,
a pH from about 3 to about 7.5.

21-28. (canceled)
